(19) United States
(12) Patent Application Publication
(10) Pub. No.: US 2024/0042451 A1
(43) Pub. Date: Feb. 8, 2024

(54) THERMAL MANAGEMENT SYSTEM

(71) Applicant: LUXEMBOURG INSTITUTE OF SCIENCE AND TECHNOLOGY (LIST), Esch-sur-Alzette (LU)

(72) Inventors: Veneranda LOPEZ DIAS, Esch-sur-Alzette (LU); Julian KLAUS, Bonn (DE); Laurent PFISTER, Belvaux (LU); Olivier DE CASTRO, Niederkorn (LU); Christophe HISSLER, Thionville (FR); Hung Quang HOANG, Esch-sur-Alzette (LU); Francois BARNICH, Bastogne (BE); Rachid BARRAHMA, Soleuvre (LU)

(21) Appl. No.: 18/254,462

(22) PCT Filed: Nov. 24, 2021
(86) PCT No.: PCT/EP2021/082789

§ 371 Date: May 25, 2023

(30) Foreign Application Priority Data
Nov. 25, 2020 (LU) 102232

(51) Int. Cl. B01L 7/00; G01N 1/42

(52) U.S. Cl. CPC B01L 7/54; G01N 1/42; B01L 2300/1894; B01L 2300/1805; B01L 2300/1883; B01L 3/5082

(57) ABSTRACT

A thermal management system comprising: a thermal source of low to cryogenic temperature; a heating element for heating the source; a shield adapted to exchange heat by conduction to/from a sample and to/from the source; a controller calibrated for maintaining a gradient of temperature along the shield within a pre-determined range; a vacuum sealing feedthrough comprising a thermal insulator element, the vacuum sealing feedthrough delimiting around the first interface a vacuum sealed volume so that the shield exchanges heat with the thermal source exclusively by conduction and exclusively at a first interface. An exemplary purpose for this thermal management system is the sublimation of water ice and/or water ice trapped in a regolith, and positioned in a vacuum chamber. The heat insulator element is configured to separate physically the thermal source from a vacuum chamber into which the shield can protrude, so that sublimated compounds from the sample do not encounter colder point which would cause their deposition on the shield or on the walls of the chamber.

### CROSS-REFERENCE TO RELATED APPLICATIONS

The present invention is the US national stage under 35 U.S.C. § 371 of International Application No. PCT/EP2021/082789 which was filed on Nov. 24, 2021, and which claims the priority of application LU102232 filed on Nov. 25, 2020 the contents of which (text, drawings and claims) are incorporated here by reference in its entirety.

### FIELD

The invention relates to experimental devices for analysing the content of a sample and more particularly to analyse a sample in an environment with substantially homogenous temperature.

### BACKGROUND

The document U.S. Pat. No. 8,847,595 B2 gives an example of a nuclear magnetic resonance apparatus, wherein the temperature of a sample tube is controlled with a plurality of interleaved, concentric flow channels. A low gradient of temperature is thus achievable by means of a flow of air or nitrogen. Since a flow of gas is required to maintain the low gradient of temperature in the sample tube, this temperature control device is not adapted for maintaining a low gradient of temperature around a sample that is maintained under vacuum. It is also not adapted to apply a low gradient of temperature to a sample that is to be analysed at cryogenic temperature. Such conditions may for instance be useful when sublimating water ice from a regolith for quantitative and isotope analyses, at low pressure (<10⁻⁵ mbar) and low temperature (<−160° C.).

There is therefore a need for a thermal management system that is adapted to maintain and measure a low temperature gradient and that can be used for experimental devices where the sample is placed under vacuum and at very low temperature.

### SUMMARY

The invention aims at providing a thermal management system which can ensure a low gradient of temperature to a sample and its surrounding environment, placed under vacuum and at low to cryogenic temperature.

The invention relates to a thermal management system comprising: a thermal source of low to cryogenic temperature; a thermal sensor for measuring a temperature at a location of the source; a heating element for heating the source; a shield having a first end in direct contact with the thermal source at a first interface, and a second end adapted to exchange heat by conduction to/from a sample; two thermal sensors arranged on the shield to measure a gradient of temperature; a controller calibrated for controlling the heating element in response to signals from the thermal sensors so as to maintain the gradient of temperature within a pre-determined range; a vacuum sealing feedthrough comprising a thermal insulator element and optionally a flange, the vacuum sealing feedthrough delimiting around the first interface a vacuum sealed volume so that the shield exchanges heat with the thermal source exclusively by conduction and exclusively at the first interface.

The shield of the thermal management system is destinated to, but not limited to, surround a sample positioned in a chamber that is put under vacuum. Foreseeing the shield and the thermal source as two distinct parts enable to control the temperature by applying heat at a distance from the position where the sample is to be positioned. The cold source is physically separated from the vacuum chamber, the thermal insulator insulating thermally the vacuum chamber' walls and optionally the isolating flange' walls from the cold source and from the shield. This distance and the insulator play a respective role in lowering the gradient of temperature applied to the sample.

According to an exemplary embodiment, the thermal source comprises a heat exchange element for instance in the form of a cold finger or a cold plate. Various other kinds or shapes of heat exchange can be used alternatively.

According to an exemplary embodiment, the heating element is arranged inside the heat exchange element. This enables a homogeneous radial heating. It also ensures the core of the heat exchange element to be warmer than its periphery.

According to an exemplary embodiment, the heating element is positioned at a location remote from the shield. This enables a steady state with a low temperature gradient for the shield.

According to an exemplary embodiment, the shield is of tubular shape. Alternatively, the shield can have a generally elongated shape with a cross-section that can be partly curved such as an arc of tube, or a closed cross-section such as a polygon, an ellipse or a circle. Thus, the shape of the shield may be such that it can surround at least partially a sample or a sample tube. It has to be noted that the shield not only transfers heat by conduction between the heat exchange element and the sample but it also offers other advantages: it shields the sample from radiative heat transfer from the chamber's walls; it favours an environment within which the gradient of temperature can be controlled and can be low; and it protects the sample from contamination, since the particles within the chamber will deposit on the shield and not on the sample when the whole assembly (shield, sample holding system and sample) are driven to low/cryogenic temperatures.

According to an exemplary embodiment, the shield is equipped with a heating element. This enables to obtain an even lower gradient by acting directly on the shield.

According to an exemplary embodiment, the shield comprises an aperture to enable the evacuation of gas from a sample positioned therein. When the experiment at stake involves vaporization or sublimation, it may be of importance to not maintain the sublimated compound within the boundaries of the shield. An aperture thus allows this evacuation.

According to an exemplary embodiment, the shield further comprises a snapping mechanism configurated for holding a sample holder.

According to an exemplary embodiment, the system further comprises a sample holder configured to be releasably coupled to the shield, allowing thermal coupling between the sample holder and the shield. It may indeed be advantageous to provide a sample holder for manipulating the sample and adapted for quickly contacting the shield.

According to an exemplary embodiment, the system further comprises a transfer device, for instance a transfer rod for handling the sample or the sample holder, wherein the transfer device is configured to move between a retracted position and an inserted position, wherein optionally the sample holder engages the shield when the transfer device is in its inserted position. This enables an automatization of the manipulation of the sample.

According to an exemplary embodiment, the system further comprises a thermal insulator element to insulate thermally the sample or the sample holder from the transfer device.

According to an exemplary embodiment, the system further comprises a bayonet coupler for removably coupling the sample or sample holder to the transfer device, and optionally a thermal insulator element to insulate thermally the bayonet coupler from the transfer device.

According to an exemplary embodiment, the insulator is configured to separate physically the thermal source from a vacuum chamber into which the shield may protrude, the insulator insulating thermally the walls of such a vacuum chamber and optionally the walls of the isolating flange from the thermal source and from the shield.

The invention also relates to a high-vacuum system comprising: a high-vacuum chamber adapted to receive a sample under high vacuum and low to cryogenic temperatures; a sample holder adapted to be positioned in the chamber; a thermal management system according to any of the embodiments described above, wherein the shield protrudes into the chamber so as to exchange heat with a sample positioned on the sample holder.

According to an exemplary embodiment, the system comprises a holding subsystem comprising: the sample holder, having a generally axisymmetric shape and provided with a peripheral groove for snap-in thermal coupling of the sample holder to the shield; a bayonet coupler for releasably coupling the holder to a transfer device; an adapter inserted into a recess of the holder; a radiation shield mounted on the adapter or on the holder.

The invention also relates to a holding subsystem for holding a sample or a sample container, the subsystem comprising: a sample holder having a recess, and optionally having an axisymmetric shape and provided with a peripheral groove for snap-in thermal coupling to a shield; a bayonet coupler for releasably coupling the holder to a transfer device; a sample container adapter inserted into the recess of the sample holder and thermally coupled to the sample holder; a radiation shield optionally mounted on the adapter or on the sample holder; at least one temperature sensor configured to measure the temperature in the sample holder and/or in the sample and/or in the adapter and/or in the vicinity of the sample holder, such as in a volume between the sample holder and the shield when coupled to the sample holder.

The several aspects of the invention ensure to various degrees to maintain and precisely measure a low gradient of temperature along the shield and adapted for a sample that is put under vacuum and at low to cryogenic temperature. A low gradient of temperature is particularly advantageous as it enables a precise control of the temperature within the sample and its surrounding environment and it prevents the presence of colder points prone to gas deposition.

### DRAWINGS

FIG. 1 is an exemplary schematic illustration of the thermal management system according to the invention.

FIG. 2 is an exemplary cross-section of a detailed design of the thermal management system, according to the invention.

FIG. 3 is an exemplary isometric view of a sample holding system, according to the invention.

FIG. 4 is an exemplary isometric view of a sample tube arranged on an adapter, according to the invention.

FIG. 5 is an exemplary isometric view of the coupling between the shield and the sample holder, according to the invention.

### DETAILED DESCRIPTION

The following examples and drawings are given for illustration purposes only. The invention is not limited by these examples but only by the appended claims. The various parts of the system can have various properties or be embodied in various ways. Each variant of each part of the system can be combined with each variant of any other parts of the system, unless explicitly mentioned otherwise.

The drawings are schematic and not drawn to scale. Some elements of the system are not illustrated, such as for example: elements for assembling the various parts together (flanges, screws, etc.), elements for properly ensuring sealing of various compartments (seals, etc.), or elements for controlling the system (wires, sensors, actuators, valves, safety devices, etc.).

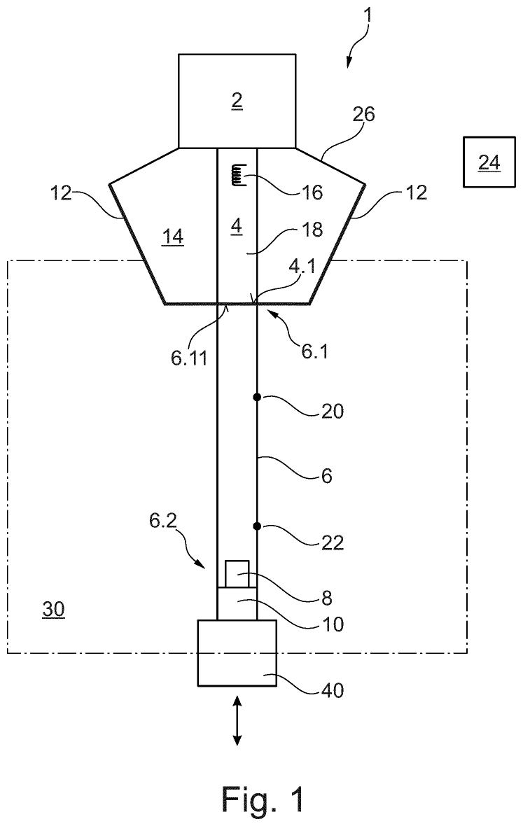

FIG. 1 shows a schematic illustration of a thermal management system 1. The system 1 comprises a thermal source 2, 4 which in an exemplary arrangement is made of a cooling system 2 thermally connected to a heat exchange element 4. The cooling system can be a Dewar containing a cryogenic fluid (LN2, LHe, etc.), a cryostat, a cooling machine, etc. The heat exchange element 4 can be a cold plate, a cold rod, a cold finger, etc.

In one embodiment, the heat exchange element 4 is a cold rod. It can be made of CuBe₂ and can be gold plated. It can have an upper conical part connected to the cooling system (e.g., LN2 Dewar).

A shield 6 is in direct contact with the heat exchange element 4. The shield 6 has a first end 6.1 with a surface 6.11 in direct contact with the lower surface 4.1 of the heat exchange element 4. A second end 6.2 of the shield 6, opposite the first end 6.1 is adapted to exchange heat with a sample 8. The thermal contact between the shield 6 and the heat exchange element 4 happens exclusively at the first surface 6.11. The heat exchange element 4 can have a cylindrical or tubular lower part that is connected with the shield 6.

The shield 6 can be of tubular shape. Alternatively, the shield 6 can have a generally elongated shape with a cross-section that can be partly curved such as an arc of tube, or a closed cross-section such as a polygon, an ellipse or a circle.

The shield 6 can be made of Cu (0 free) and/or can be gold plated for increased heat conductivity and for reducing water adsorption. The second end 6.2 of the shield 6 can enable a snap-in rapid coupling of the shield 6 with the sample 8 or with a sample holder 10, for instance through leaf springs and ruby spheres arrangement. In an embodiment, the thermal management system is positioned vertically, the first end 6.1 being an upper end, while the second end 6.2 is a lower end. The drawings and part of the description are directed to this vertical orientation. Alternatively, the system 1 can be positioned horizontally or obliquely.

The sample 8 can be a sample tube or any other sample container, provided with a compound to be analysed. The sample can alternatively be self-contained. In exemplary embodiments, the compound is water ice or a lunar regolith containing water ice. The sample 8 can be handled together with the sample holder 10.

An insulator 12 is provided to surround at least a portion of the heat exchange element 6. A vacuum sealed volume 14 is defined between the heat exchange element 4 and the insulator 12. Appropriate pumping mechanism and/or valves are provided to ensure a dynamic or static vacuum in the volume 14. The insulator 12 thus ensures the thermal insulation of the heat exchange element 4 from the environment. The insulator 12 also separates physically the cold source 2, 4 from the sample 8.

At least one heating element 16 is provided on the heat exchange element 4 to bring the heat exchange element 4 at a higher temperature than the cooling system 2. The heating element 16 can be an electric wire or a heating foil.

The heating element 16 can be arranged internally to the heat exchange element 4 to provide for a more homogeneous temperature at the radially outer periphery of the heat exchange element 4.

The heating element 16 can be positioned at a first half location of the heat exchange element 4, i.e., closer to the cooling system 2 than the shield 6. Optionally, a second heating element (not shown) can be provided at a second half location of the heat exchange element 4. Further heating elements (wires inside the element 4 and/or heating foil outside of it) can be provided at locations closer to the shield 6.

Thermal sensors 18, 20, 22, for example pt100 temperature sensors, are provided on the heat exchange element 4 and the shield 6 to measure the temperature at a location of the heat exchange element 6 and at two locations of the shield, so as to deduce a gradient of temperature over the shield 6. Further sensors can be provided.

When the heating element 16 is complemented with additional heating elements to heat the heat exchange element 4, further thermal sensors can be provided at various locations of the heat exchange element 4.

The sensors 18, 20, 22 transmit measured temperatures to a controller 24 which acts on the heating element 16. The controller 24 is calibrated to control the heating element 16 as a function of the temperatures and gradient of the temperature, thereby maintaining the gradient within a pre-determined range. This range of temperature can amount to a few K, for example less than 5K, or less than 2K. The calibration is done by empiric learning or by simulation. Based on the temperature from the sensor 18 and the gradient of temperature measured from sensors 20, 22, the controller is thus able to determine the amount of energy that the heating element 16 must bring to the heat exchange element 4 (both in terms of power and duration to obtain a steady state).

The shield 6 can also be provided with heating elements (not shown) of the same type as those 16 of the heat exchange element 4. The heating elements on the shield 6 can alternatively be heating foils, attached to the shield by means of gold-plated copper clamps.

The heat exchange element 4 and/or the shield 6 can be gold plated to maximise the heat transfer while preventing water vapour adsorption. This also contributes to a homogeneous temperature distribution throughout the shield 6.

A flange 26 can also be provided. It isolates the lower part of the cooling system 2 from its environment. It can create a vacuum volume around the upper part of the heat exchange element 4, or can be joined to the insulator to create a common vacuum sealed volume around the heat exchange element 4.

In an exemplary but not exclusive embodiment, a chamber 30 is provided for receiving the sample under vacuum, high vacuum or ultra-high vacuum. The insulator 12 insulates thermally the heat exchange element 4 and the first end of the shield from the walls of the chamber 30 and or from the walls of the flange, to ensure that the walls do not heat up the heat exchange element 4, or that the heat exchange element 4 does not cool some areas of the walls. The outer surface of the walls of the chamber can indeed be at room temperature. Likewise, the insulator isolates (in the sense that it separates physically) the cooling system 2 and the heat exchange element 4 from the chamber 30, to ensure that the coldest parts of the thermal management system are not inside the chamber.

Thus, the insulator 12 prevents any point within the chamber 30 to be colder than the shield. Thus, during experiments where the sample evaporates or sublimates, the gases do not condensate or deposit on the camber's walls and/or on the thermal management system elements. This can be particularly advantageous when further analyses are to be done on the gas, as they can be easily evacuated out of the chamber.

For such an experiment, the shield 6 can have an aperture through which the gas can escape from the environment around the sample, so as to be collected and analysed. The thermal sensors 20, 22 can be arranged below and above the aperture respectively.

The surface 6.11 at the interface with the heat exchange element 4 is confined to the vacuum sealed volume 14. The heat exchange element 4 does not protrude out of the insulator 12 or into the chamber 30.

The insulator 12 also isolates the shield 6 from the cooling system 2 and the vacuum in the chamber 30 isolates the shield 6 from the environment. Hence, the shield 6 only exchanges heat by conduction at the surface 6.11 with the heat exchange element 4, and only exchanges heat by conduction at the second end 6.2 with the sample 8 or sample holder 10. The shield 6 exchanges heat by radiation with the walls of the chamber 30—although radiative heat in vacuum is low. The shield 6 protects the sample from such radiation.

Therefore, when the heat exchange element 4 is heated with the wire 16, heat is transferred by conduction to the shield 6, but the cooling system 2 is not in contact with the shield 6 and not reachable by vapours from the sample.

The fact that heat is exchanged by conduction between the cooling system 2, the heat exchange element 4, shield 6 and the sample 8 enables a faster heat transfer than a radiational heat transfer.

The cooling system is first able to cool down the sample because the heat is transferred by conduction from the sample to the cooling system. Then, once the sample is at very low temperatures, heating corresponds to warming up the heat exchange element, thereby transferring heat by conduction from the heat exchange element to the sample.

The insulator 12 can be made of polyether ether ketone (PEEK) and constitutes a feedthrough for the shield 6. It can be provided with a heating foil and a pt100 temperature sensor to regulate its temperature (for instance by the controller 24).

For automatically handling the sample holder 10 and the sample 8, the system can be provided with a transfer system 40.

Next to the vacuum chamber 30 (i.e., above, below or aside), a manipulation area, manipulation chamber or a transfer shuttle can be arranged where an operator can manipulate and or transfer the sample. Once the sample is ready for the analyses, the transfer system 40 transfers it to the vacuum chamber 30. The transfer system 40, the sample holder 10 and the shield 6 are such that the transfer system 40 brings the sample holder 10 into contact for quick coupling to the shield 6.

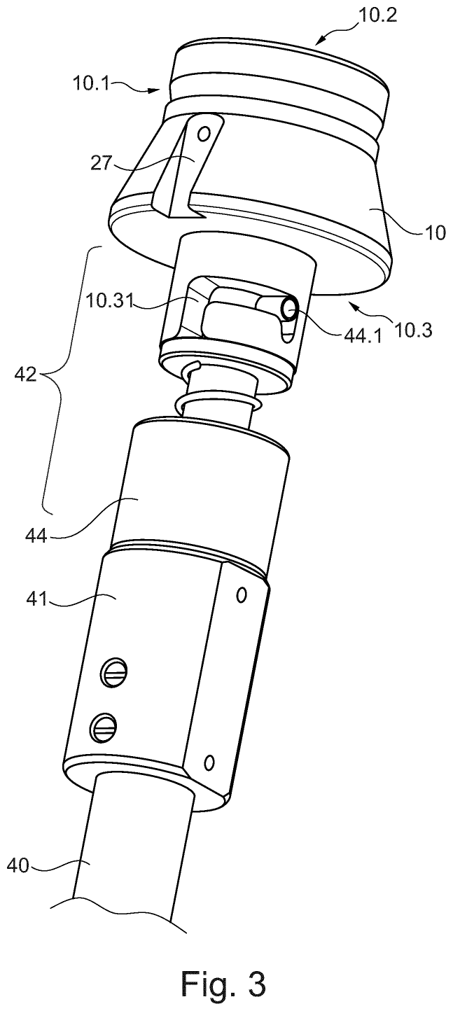

The sample holder 10 and its connection to the transfer system 40 will be further described in relation with FIG. 3.

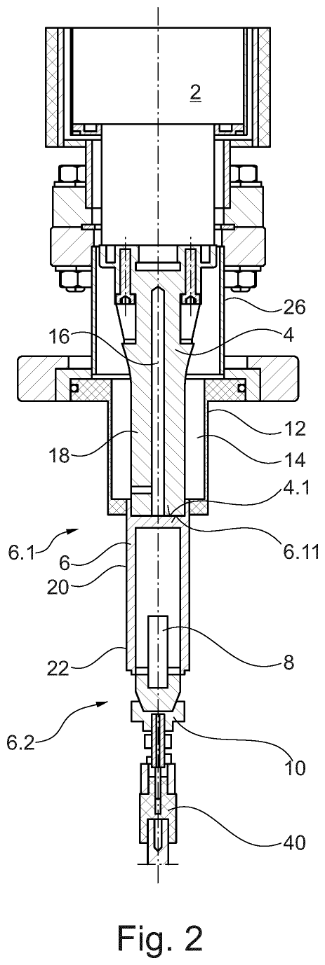

FIG. 2 shows an example of an embodiment of the thermal management system 1 of the invention. The same numbers refer to the same parts as discussed in relation to FIG. 1.

The thermal source can be a LN2 Dewar to which is coupled a cold rod 4. The rod 4 has a central hole that receives a heating wire 16. The rod 4 can have a first end (upper part when arranged vertically) that is generally conical and a second end (lower part) that is generally cylindrical. The shield 6 is tubular.

The shield 6 surrounds the sample in the sense that it creates a volume that is at least partially closed around the sample.

At the bottom of FIG. 2, a sample holder 10 is shown. This holder 10 can be snapped in the tube 6. This enables the retractation of the rod 40 to ensure that the sample holder is only touching the shield 6 and is thus only thermally exchanging heat with the shield 6 on the one hand and with the sample 8 on the other hand, during a heating process.

FIG. 3 shows a detailed example of a sample holder 10. The sample holder 10 can have an external peripheral groove 10.1 aimed at engaging corresponding features of the shield 6, such as leaf springs with rubies, fingers, flanges, etc.

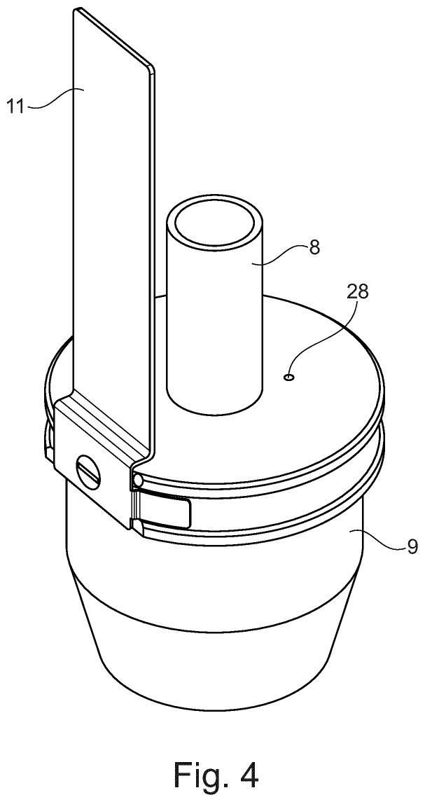

The sample holder 10 has an upper portion 10.2 with a recess (e.g., drilled hole) to receive the sample tube (see FIG. 4). The recess can have several, progressively narrowing diameters, so as to receive various diameters of sample tubes or sample adapters.

The holder 10 can be made of gold plated CuBe₂. In use, the temperature distribution within the sample tube holder is homogeneous.

The sample tube holder 10 can have an integrated pt100 temperature sensor. Additionally, it can have two thermocouples, which can be introduced through a groove inside the tubular shield 6 to measure the temperature inside of the sample, in the sample tube 8, in the upper part of the sample, in the adapter or where it could be required within the inner volume of the tubular shield 6. The controller 24 can also react to those temperature measurements for regulating the temperature gradient along the whole ensemble (tubular shield, sample holder, adapter, sample container and sample).

The holder 10 also has a lower portion 10.3 which can form a female connector of a bayonet coupling 42, while a male connector 44 is connected to the transfer device 40. A pair of opposite studs 44.1 of the male connector 44 engage a pair of grooves 10.31 of the female connector 10.3. A thermal insulator element 41 can be interposed between the male connector 44 and the transfer device 40.

The transfer device 40 can be a rod.

The bayonet coupling 42 enables to releasably couple the sample holder 10 to the transfer rod. Thus, the sample and sample holder are moved by the transfer rod and once the sample holder 10 is coupled to the shield 6, the transfer rod can be retracted.

In one embodiment, the transfer rod will not be fully retracted because the temperature sensors are connected to the controller through the rod. Nevertheless, the bayonet coupler 42 will be detached and the transfer rod retracted a few centimetres to avoid the heat transfer between the sample tube holder and the bayonet coupler 42. It is also possible to carry out experiments where the temperature in the sample holding and transfer system will not be measured. In that case, the temperature sensors will be disconnected, and the sample tube holder 10 can be attached to the tubular shield 6, the transfer rod fully retracted out of the vacuum chamber.

The bayonet coupler 42 can be made of stainless steel. A PEEK insulator can be arranged between the bayonet coupler 42 and the holder 10.

A thermal sensor 27 can be arranged on the holder 10.

FIG. 4 shows an exemplary detailed embodiment of a sample. The sample can be constituted by a sample tube 8 containing the sample, held by an adapter 9 which is adapted to engage the recess of the holder 10.

The sample tube 8 can be made of quartz. The thickness of the wall can be of about 0.4 mm. It is introduced into an opening in the sample tube adapter 9, whose diameter matches the outer diameter of the sample tube 8.

Silver paint can be applied between the sample tube adapter 9 and the sample tube 8 and can dry before introducing the sample.

The sample adapter 9 can follow the same preparation procedure as the sample tube 8 before experimentation. For example, both can be transported, together with the sample, in a closed container filled with LN2. Since quartz has a low thermal expansion coefficient, temperature induced volume change can be considered negligible for the wide range of temperature changes considered for a sublimation experiment. Therefore, the sample tube 8 will not break due to the mechanical stress between the metallic sample holder 10 and the quartz tube caused by thermal expansion. Likewise, since quartz is a bad thermal conductor, the sample is expected to heat more homogeneously when the system is heated. When the sample is being heated, its environment (including tubular shield 6 and sample tube holder 10) will already have a stable temperature and the heat is transmitted by conduction from the tube holder 10 to the tube adapter 9 and to the quartz tube 8. Heat will come to the sample in a slow and accommodating manner. Additionally, the quartz will allow to perform some optical measurements when needed through a quartz view port, which can be placed in the vacuum chamber.

A Teflon or quartz frit filter can cover the top of the tube so as to prevent any solid/liquid material escaping the tube.

In case a faster sample heating is required, the quartz sample tube can be substituted by a gold-plated Cu (O free) sample tube. This can be an excellent thermal conductor and the gold plating can make the metallic surface more inert and less likely to adsorb water. This design can ensure the absence of thermal gradients when the length of the sample tube is greater. Thermal simulations have shown that for a quartz tube with 0.5 mm wall thickness, 40 mm length and 6 mm diameter, a gradient of less than 1° C. can be expected along the tube.

The sample tube adapter 9 can be made of molybdenum. Molybdenum has a low thermal expansion coefficient, preventing breakage of the tube under wide variations of temperature.

A thermal sensor 28 can be arranged on the adapter 9.

A gold-plated Cu (O free) shielding sheet 11 is provided onto the sample tube adapter 9 and placed in front of a tubular shield's 6 aperture to protect the sample tube 8 from radiative heat transfer from the environment. The height of the sheet 11 is at least equal to the height of the sample tube 8.

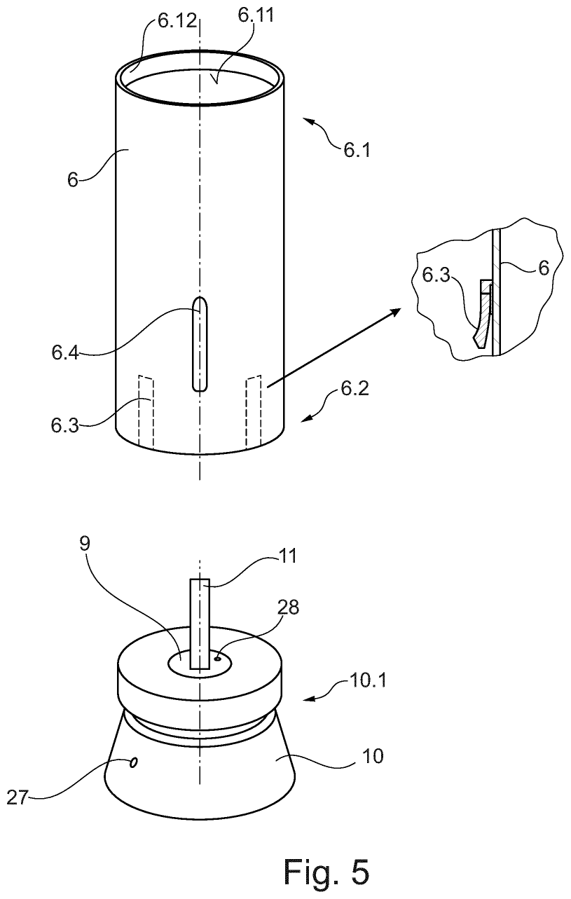

FIG. 5 shows the respective positions of the shield 6 and the sample holder 10 before coupling. In this example, the shield 6 is substantially tubular, i.e., defining an internal cavity for receiving the sample. The first end surface 6.11 of the shield 6 is not hollow.

The shield 6 can have a protruding ring 6.12 into which the heat exchange element 4 can be inserted.

The shield 6 has features 6.3 at is lower end 6.2 which can cooperate with the sample holder 10 and more specifically leaf springs with rubies which cooperate with the groove 10.1 of the sample holder 10. The leaf springs 6.3 can be arranged inside the shield 6 as shown in the cross-section on the right-hand side of FIG. 5 or alternatively outside of the shield 6.3.

The shield 6 has an aperture 6.4 for the evacuation of gas. When inserted in the tube, the radiation shield 11 is such that it protects the sample tube from any radiation passing through the aperture 6.4.

A possible use of the thermal management system 1 can be in a sublimation system. Such a sublimation system can comprise a thermal management system 1 with a shield 6 protruding into a sublimation chamber 30. A manipulation chamber can be arranged below the sublimation chamber 30 and a transfer system 40 is configured to transfer the sample into and out of the sublimation chamber 30. The thermal management system 1 aims at maintaining the sample at very low temperature and heating up the sample in the chamber 30 under vacuum, such that compounds sublimate from the sample.

The chamber 30 can have an exit that enables collection and/or analysis of the sublimated compounds. The thermal management system 1 enables a low gradient of temperature along the whole assembly (shield, holding system and sample) and prevents colder points within the chamber 30, so that no deposition of the sublimated compounds occurs within the chamber 30 and the entirety of the sublimated compounds is collected, e.g., by evacuation, through the exit.

What is claimed is:

1.-16. (canceled)

17. A thermal management system comprising:
a thermal source of low to cryogenic temperature;
a thermal sensor for measuring a temperature at a location of the thermal source;
a heating element for heating the thermal source;
a shield having a first end in direct contact with the thermal source at a first interface, and a second end adapted to exchange heat by conduction to/from a sample;
two thermal sensors arranged on the shield to measure a gradient of temperature;
a controller calibrated for controlling the heating element in response to signals from the two thermal sensors, thereby maintaining the gradient of temperature within a pre-determined range; and
a vacuum sealing feedthrough comprising a thermal insulator element and optionally a flange, the vacuum sealing feedthrough delimiting around the first interface a vacuum sealed volume so that the shield exchanges heat with the thermal source exclusively by conduction and exclusively at the first interface.

18. The thermal management system according to claim 17, wherein the thermal source comprises a heat exchange element for instance in the form of a cold finger or a cold plate.

19. The thermal management system according to claim 18, wherein the heating element is arranged inside the heat exchange element.

20. The thermal management system according to claim 17, wherein the heating element is positioned at a location remote from the shield.

21. The thermal management system according to claim 17, wherein the shield is of tubular shape.

22. The thermal management system according to claim 17, wherein the shield is equipped with a heating element.

23. The thermal management system according to claim 17, wherein the shield comprises an aperture to enable the evacuation of gas from a sample positioned therein.

24. The thermal management system according to claim 17, wherein the shield further comprises a snapping mechanism configured for holding a sample holder.

25. The thermal management system according to claim 17, further comprising a sample holder configured to be releasably coupled to the shield, allowing thermal coupling between the sample holder and the shield.

26. The thermal management system according to claim 25, further comprising a transfer device configured to move between a retracted position and an inserted position.

27. The thermal management system according to claim 26, wherein the transfer device is a transfer rod for handling the sample or the sample holder.

28. The thermal management system according to claim 26, wherein the sample holder engages the shield when the transfer device is in its inserted position.

29. The thermal management system according to claim 26, further comprising a thermal insulator element to insulate thermally the sample or the sample holder from the transfer device.

30. The thermal management system according to claim 26, further comprising a bayonet coupler for removably coupling the sample or sample holder to the transfer device.

31. The thermal management system according to claim 30, further comprising a thermal insulator element to insulate thermally the bayonet coupler from the transfer device.

32. The thermal management system according to claim 17, wherein the insulator is configured to separate physically the thermal source from a vacuum chamber into which the shield may protrude, the insulator insulating thermally the walls of such a vacuum chamber and optionally the walls of the isolating flange from the thermal source and from the shield.

33. A high-vacuum system comprising:
a high-vacuum chamber adapted to receive a sample under high vacuum and low to cryogenic temperatures;
a sample holder adapted to be positioned in the chamber; and
a thermal management system comprising:
a thermal source of low to cryogenic temperature;
a thermal sensor for measuring a temperature at a location of the thermal source;
a heating element for heating the thermal source;
a shield having a first end in direct contact with the thermal source at a first interface, and a second end adapted to exchange heat by conduction to/from a sample;
two thermal sensors arranged on the shield to measure a gradient of temperature;
a controller calibrated for controlling the heating element in response to signals from the two thermal sensors, thereby maintaining the gradient of temperature within a pre-determined range; and
a vacuum sealing feedthrough comprising a thermal insulator element and optionally a flange, the vacuum sealing feedthrough delimiting around the first interface a vacuum sealed volume so that the shield exchanges heat with the thermal source exclusively by conduction and exclusively at the first interface,
wherein the shield protrudes in the chamber so as to exchange heat with a sample positioned on the sample holder.

34. The high-vacuum system according to claim 33, further comprising:
a holding subsystem comprising:
the sample holder, having a generally axisymmetric shape and provided with a peripheral groove for snap-in thermal coupling of the sample holder to the shield;
a bayonet coupler for releasably coupling the holder to a transfer device;
an adapter inserted into a recess of the holder; and
a radiation shield mounted on the adapter or on the holder.

35. The high-vacuum system according to claim 34, wherein the holding subsystem further comprises:
at least one temperature sensor configured to measure the temperature in at least one of the following:
in the sample holder;
in the sample;
in the adapter; and
in the vicinity of the sample holder,
such as in a volume between the sample holder and the shield when coupled to the sample holder.
